(19) United States
(12) Patent Application Publication
(10) Pub. No.: US 2022/0341965 A1
(43) Pub. Date: Oct. 27, 2022

(54) ELECTRONIC DEVICE WITH FUNCTION OF RECORDING FALLING AND HITTING EVENTS AND FALLING AND HITTING EVENT RECORDING METHOD THEREOF

(71) Applicant: ASUSTEK COMPUTER INC., TAIPEI (TW)

(72) Inventors: Chieh KAO, TAIPEI (TW); Yi- Cheng CHANG, TAIPEI (TW); Jheng-Siou CAI, TAIPEI (TW); Kai Yu HSU, TAIPEI (TW)

(21) Appl. No.: 17/683,578

(22) Filed: Mar. 1, 2022

(30) Foreign Application Priority Data
Apr. 22, 2021 (TW) 110114582

(51) Int. Cl. G01P 15/18

(52) U.S. Cl. CPC G01P 15/18

(57) ABSTRACT

An electronic device with function of recording falling and hitting events is provided. The electronic device includes a gravity sensing unit, a computing unit, and a memory unit. The gravity sensing unit is configured to generate a gravity sensing signal. The computing unit is electrically connected to the gravity unit and is configured to: continuously receive the gravity sensing signal; determine, based on the gravity sensing signal, whether the electronic device enters a falling state or not; determine, based on the gravity sensing signal, whether the electronic device encounters a hitting within a predetermined period of time or not after entering the falling state; and output a falling and hitting record when it is determined that the electronic device encounters a hitting. The memory unit is electrically connected to the computing unit and configured to store the falling and hitting record.

### CROSS-REFERENCE TO RELATED APPLICATION

This application claims the priority benefit of Taiwan application serial No. 110114582, filed on Apr. 22, 2021. The entirety of the above-mentioned patent application is hereby incorporated by reference herein and made a part of specification.

### BACKGROUND OF THE INVENTION

### Field of the Invention

The disclosure relates to an electronic device, and in particular, to an electronic device with function of recording falling and hitting events.

### Description of the Related Art

For a manufacturer, whether a product is damaged due to improper use or not directly affects the affirmation of the warranty maintenance scope. Traditionally, it is determined, only depending on whether an appearance is deformed or damaged, whether the product has been improperly used or not, such as a falling, a heavy hitting, and the like. In this way, the manufacturer and the user always express their opinions, easily causing confusion.

### BRIEF SUMMARY OF THE INVENTION

The disclosure provides an electronic device with function of recording falling and hitting events. The electronic device includes a gravity sensing unit, a computing unit, and a memory unit. The gravity sensing unit is configured to generate a gravity sensing signal. The computing unit is electrically connected to the gravity sensing unit and configured to: continuously receive the gravity sensing signal; determine, based on the gravity sensing signal, whether the electronic device enters a falling state or not; determine, based on the gravity sensing signal, whether the electronic device encounters a hitting within a predetermined period of time or not after entering the falling state when it is determined that the electronic device enters the falling state; and output a falling and hitting record when it is determined that the electronic device encounters the hitting. The memory unit is electrically connected to the computing unit and configured to store the falling and hitting record.

The disclosure further provides a falling and hitting event recording method adapted to an electronic device. The electronic device includes a gravity sensing unit and a memory unit. The falling and hitting event recording method includes: continuously receiving, by the gravity sensing unit, a gravity sensing signal; determining, based on the gravity sensing signal, whether the electronic device enters a falling state or not; determining, based on the gravity sensing signal, whether the electronic device encounters a hitting within a predetermined period of time or not after entering the falling state when it is determined that the electronic device enters the falling state; and generating and storing a falling and hitting record in the memory unit when it is determined that the electronic device encounters the hitting.

According to the electronic device with function of recording falling and hitting events and a falling and hitting event recording method thereof in the disclosure, the improper use of the electronic device (especially the falling and hitting) by the user is accurately recorded as a basis for the warranty and maintenance scope of a manufacturer. In this way, disputes between the manufacturer and the user about warranty maintenance issues are avoided.

### BRIEF DESCRIPTION OF THE DRAWINGS

FIG. 1 is a schematic block diagram of an electronic device according to an embodiment of the disclosure.

FIG. 2 is a graph showing a change of a sensed gravity value with a time axis during a falling and a hitting of an electronic device.

FIG. 3 is a flowchart of a falling and hitting event recording method according to an embodiment of the disclosure.

FIG. 4 is a flowchart of the falling and hitting event recording method according to another embodiment of the disclosure.

### DETAILED DESCRIPTION OF THE EMBODIMENTS

More detailed descriptions of specific embodiments of the disclosure are provided below with reference to the schematic diagrams. The features and advantages of the disclosure are described more clearly according to the following description and claims. It should be noted that all of the drawings use very simplified forms and imprecise proportions, only being used for assisting in conveniently and clearly explaining the objective of the embodiments of the disclosure.

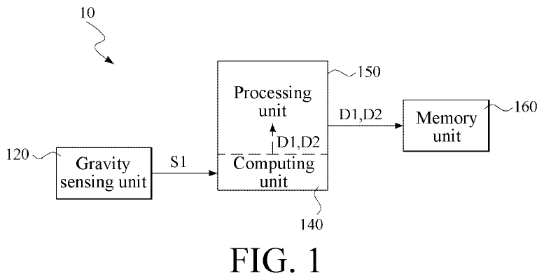

FIG. 1 is a schematic block diagram of an electronic device according to an embodiment of the disclosure. The electronic device 10 is a handheld electronic device, such as a smartphone, a tablet computer, and an electronic device that is easily dropped accidentally by a user.

As shown in the figure, the electronic device 10 includes a gravity sensing unit 120, a computing unit 140, a processing unit 150, and a memory unit 160.

The gravity sensing unit 120 is configured to detect a usage status of the electronic device 10 to generate a gravity sensing signal S1. In one embodiment, the gravity sensing unit 120 is a gravity sensor (G sensor).

In one embodiment, the gravity sensing signal S1 includes an X-axis sensed value, a Y-axis sensed value, and a Z-axis sensed value, so as to present the usage status of the electronic device 10. In an embodiment, when the electronic device 10 is in a stationary state, the gravity sensing unit 120 outputs the sensing signal of (0, 0, 1), where 1 is the Z-axis sensed value.

The computing unit 140 is a main element configured to determine whether the electronic device 10 enters a falling state or encounters a falling and a hitting. The computing unit 140 is electrically connected to the gravity sensing unit 120, continuously receives the gravity sensing signal S1 from the gravity sensing unit 120, and determines, based on the gravity sensing signal S1, whether the electronic device 10 enters the falling state or encounters the falling and hitting.

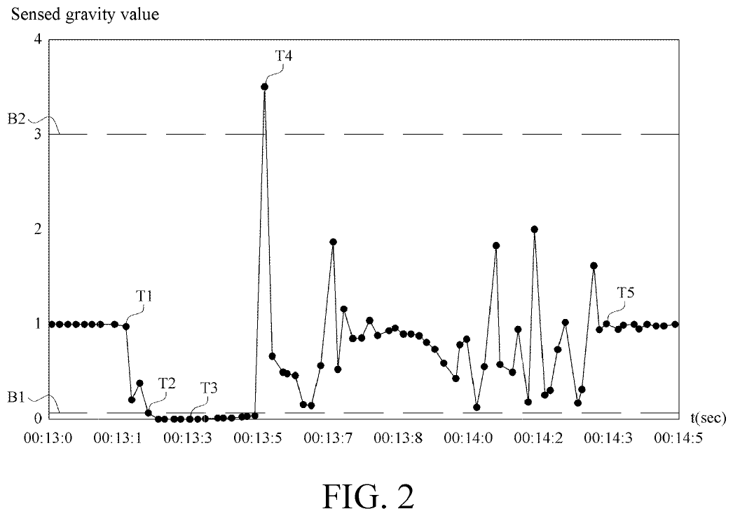

The determination method of the computing unit 140 is described in more detail in the subsequent paragraphs corresponding to FIG. 2. After the computing unit 140 determines that the electronic device 10 encounters the falling and hitting, a falling and hitting record D1 is outputted.

The processing unit 150 is electrically connected to the computing unit 140 and the memory unit 160 and configured to receive the falling and hitting record D1 and store the falling and hitting record D1 in the memory unit 160. The memory unit 160 is electrically connected to the computing unit 140 by using the processing unit 150 and configured to store the falling and hitting record D1. In this way, it is determined, by checking the record in the memory unit 160, whether the user has improperly used the electronic device 10 or not. In one embodiment, the memory unit 160 is set as a memory to which the user does not have a read permission, so as to prevent the user from modifying the record.

In one embodiment, the processing unit 150 is a central processing unit (CPU). In one embodiment, the falling and hitting record D1 is configured to wake up the processing unit 150 and notify the processing unit 150 to store the falling and hitting record D1 in the memory unit 160.

In one embodiment, the computing unit 140 is integrated into the processing unit 150. In other words, a part of the processing unit 150 is defined as the computing unit 140. The computing unit 140 is an independent operation area. When other parts of the processing unit 150 enter a dormant state, the computing unit 140 remains in an operating state, outputs the falling and hitting record D1 after determining that the electronic device 10 encounters the falling and hitting, and then wakes up other parts of the processing unit 150, so as to achieve the effect of power saving.

In the foregoing embodiment, the computing unit 140 outputs and stores the falling and hitting record D1 in the memory unit 160 when determining that the electronic device encounters the falling and hitting. However, the disclosure is not limited thereto.

In other embodiments, in addition to the falling and hitting record D1, the computing unit 140 also outputs and stores a falling record D2 in the memory unit 160 when determining that the electronic device 10 enters the falling state. In this way, a usage process of the user is recorded more completely.

FIG. 2 is a graph showing a change of a sensed gravity value with a time axis during a falling and a hitting of an electronic device. The details of the computing unit 140 in the disclosure determining, based on the gravity sensing signal S1, whether the electronic device 10 enters the falling state or encounters the falling and hitting are described in conjunction with the graph below.

The gravity sensing signal S1 includes an X-axis sensed value, a Y-axis sensed value, and a Z-axis sensed value. The computing unit 140 calculates a sum of the squares of the X-axis sensed value, the Y-axis sensed value, and the Z-axis sensed value, and extracts a square root of the sum of squares to generate the sensed gravity value in FIG. 2 for subsequent determination. The sensed gravity value is a positive value.

Before a time point T1, the electronic device 10 is in a stationary state, and at this point, the sensed gravity value is maintained at 1. After the time point T1, the electronic device 10 begins to fall, and at this point, the sensed gravity value gradually decreases.

Subsequently, at a time point T2, the sensed gravity value decreases to be less than a first preset value B1, in an embodiment, 0.05. The computing unit 140 determines that the electronic device 10 enters the falling state after the state in which the sensed gravity value is less than the first preset value B1 lasts for a predetermined period of time (that is, a time point T3). In this way, the misjudgment is avoided. In one embodiment, the predetermined period of time (that is, a time interval between T2 and T3) is set to 0.1 seconds.

Next, at a time point T4, the electronic device 10 encounters the falling and hitting, and at this point, the sensed gravity value rapidly rises to generate a peak value. The peak value is greater than a second preset value B2, such as 3. The computing unit 140 determines that the electronic device 10 encounters the falling and hitting, and outputs the falling and hitting record D1. The falling and hitting record D1 includes the sensed gravity value and the corresponding time point when the hitting is encountered.

If the sensed gravity value is still not greater than the second preset value B2 until a time point T5, it indicates that the electronic device 10 still does not encounter the falling and hitting for a predetermined period of time after entering the falling state. At this point, the computing unit 140 stops the determination of the falling and hitting. In one embodiment, the predetermined period of time (that is, a time interval between T3 and T5) is set to 1 second.

It should be noted that, after the electronic device 10 encounters the falling and hitting, the peak value greater than the second preset value B2 is still possibly generated during the bounce and rolling of the electronic device 10. In order to avoid repeated recording, the computing unit 140 only records the first sensed gravity value exceeding the second preset value B2.

Through the setting of the aforementioned first preset value B1, the daily use of the user is prevented from being determined as falling. Through the setting of the aforementioned second preset value B2, a falling situation without causing damage is prevented from being determined as the falling and hitting. In this way, a usage status of the user is accurately determined as a basis for the warranty maintenance scope.

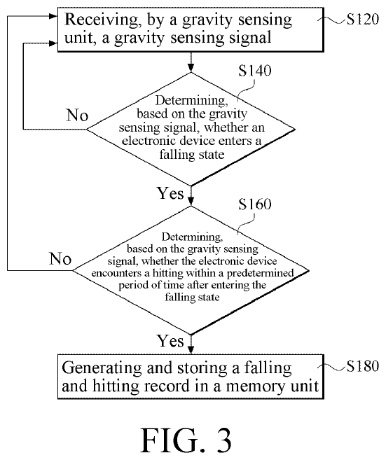

FIG. 3 is a flowchart of a falling and hitting event recording method according to an embodiment of the disclosure. The falling and hitting event recording method is applied to the electronic device 10 shown in FIG. 1. The falling and hitting event recording method includes the following steps.

Referring to FIG. 1, first in step S120, the gravity sensing signal S1 is received by the gravity sensing unit 120.

Then, in step S140 for determination, it is determined, based on the gravity sensing signal S1, whether the electronic device 10 enters the falling state or not. When it is determined that the electronic device 10 enters the falling state, the process proceeds to step S160 for determination. When it is determined that the electronic device 10 is not in the falling state, the process returns to step S120.

In step S160 for determination, it is determined, based on the gravity sensing signal S1, whether the electronic device 10 encounters a hitting within a predetermined period of time or not after entering the falling state. When it is determined that the electronic device 10 encounters the hitting, the process proceeds to step S180. When it is determined that the electronic device 10 still does not encounter the hitting within a predetermined period of time after entering the falling state, the process returns to step S120.

In step S180, the falling and hitting record D1 is generated and stored in the memory unit 160, and the recording process is ended.

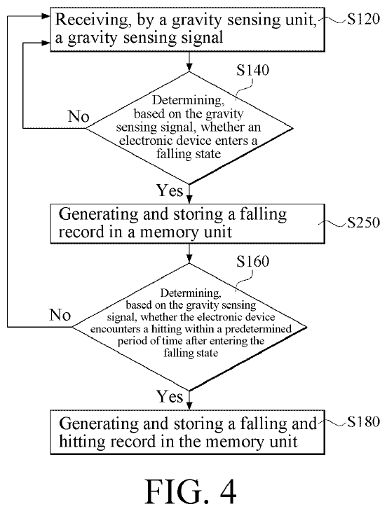

FIG. 4 is a flowchart of the falling and hitting event recording method according to another embodiment of the disclosure. The falling and hitting event recording method is applied to the electronic device 10 shown in FIG. 1. The main difference between the falling and hitting event recording method in this embodiment and that in the embodiment of FIG. 3 in the disclosure is step S250, other steps are substantially the same and are marked with the same reference numerals, and the details are not described herein again.

Carrying on with step S140 for determination, when it is determined that the electronic device 10 enters the falling state, the process proceeds to step S250 for determination. In step S250, a falling record D2 is generated and stored in the memory unit 160. Then, the process proceeds to step S160 for determination to determine whether the hitting is encountered or not.

Compared with the embodiment in FIG. 3, in this embodiment, in addition to the falling and hitting record D1 outputted and stored in the memory unit 160, the falling record D2 is outputted and stored in the memory unit 160 when it is determined that the electronic device 10 enters the falling state. In this way, a usage process of the user is recorded more completely.

According to the electronic device 10 with function of recording falling and hitting events and a falling and hitting event recording method thereof in the disclosure, the improper use of the electronic device 10 (especially the falling and hitting) by the user is accurately recorded as a basis for the warranty and maintenance scope of a manufacturer. In this way, disputes between the manufacturer and the user about warranty maintenance issues are avoided.

The above is merely exemplary embodiments of the disclosure, and does not constitute any limitation on the disclosure. The disclosure is implemented in any appropriate form. Any form of equivalent replacements or modifications to the technical means and technical content disclosed in the disclosure made by a person skilled in the art without departing from the scope of the technical means of the disclosure still fall within the content of the technical means of the disclosure and the protection scope of the disclosure.

What is claimed is:

1. An electronic device with function of recording falling and hitting events, comprising:
a gravity sensing unit, configured to generate a gravity sensing signal;
a computing unit, electrically connected to the gravity sensing unit and configured to:
continuously receive the gravity sensing signal;
determine, based on the gravity sensing signal, whether the electronic device enters a falling state or not;
determine, based on the gravity sensing signal, whether the electronic device encounters a hitting within a predetermined period of time or not after entering the falling state when it is determined that the electronic device enters the falling state; and
output a falling and hitting record when it is determined that the electronic device encounters the hitting; and
a memory unit, electrically connected to the computing unit and configured to store the falling and hitting record.

2. The electronic device according to claim 1, further comprising a processing unit electrically connected to the computing unit and the memory unit and configured to receive the falling and hitting record, determine an operation state of the electronic device based on the falling and hitting record, and store the falling and hitting record in the memory unit.

3. The electronic device according to claim 2, wherein the falling and hitting record is used to wake up the processing unit.

4. The electronic device according to claim 2, wherein the computing unit is integrated with the processing unit.

5. The electronic device according to claim 1, wherein the gravity sensing signal comprises an X-axis sensed value, a Y-axis sensed value, and a Z-axis sensed value, and the computing unit determines, based on a sensed gravity value generated in accordance with the X-axis sensed value, the Y-axis sensed value, and the Z-axis sensed value, whether the electronic device enters the falling state or not, and determines, based on the sensed gravity value, whether the electronic device encounters the hitting or not.

6. The electronic device according to claim 5, wherein when the sensed gravity value is less than a first preset value, the computing unit determines that the electronic device enters the falling state.

7. The electronic device according to claim 5, wherein when the sensed gravity value is greater than a second preset value, the computing unit determines that the electronic device encounters the hitting.

8. The electronic device according to claim 5, wherein the falling and hitting record comprises the sensed gravity value and a corresponding time point when the hitting is encountered.

9. The electronic device according to claim 1, wherein when the computing unit determines that the electronic device enters the falling state, the computing unit outputs and stores a falling record in the memory unit.

10. A falling and hitting event recording method, adapted to an electronic device, the electronic device comprising a gravity sensing unit and a memory unit, the falling and hitting event recording method comprising:
continuously receiving, by the gravity sensing unit, a gravity sensing signal;
determining, based on the gravity sensing signal, whether the electronic device enters a falling state or not;
determining, based on the gravity sensing signal, whether the electronic device encounters a hitting within a predetermined period of time or not after entering the falling state when it is determined that the electronic device enters the falling state; and
generating and storing a falling and hitting record in the memory unit when it is determined that the electronic device encounters the hitting.
